(19) United States
(12) Patent Application Publication
(10) Pub. No.: US 2011/0268838 A1
(43) Pub. Date: Nov. 3, 2011

(54) IN-CONTAINER BEVERAGE ENHANCEMENT DEVICE AND METHOD

(76) Inventors: David A. Vondrasek, Simi Valley, CA (US); William L. Vondrasek, Simi Valley, CA (US)

(21) Appl. No.: 12/771,405

(22) Filed: Apr. 30, 2010

(51) Int. Cl. C12G 1/022; B65D 43/04; C12G 3/07; C12H 1/22

(52) U.S. Cl. 426/15; 99/277.1; 220/801

(57) ABSTRACT

Appropriate types of wooden pieces, such as oak, rosewood, redwood, cedar, birch, or beech sticks, rods, or balls, are coupled with the cap or cork of a bottle. The wooden pieces are configured to be removably extended into a beverage container for on-shelf or after-consumer-sale enhancement of beverage. This way, while the beverage bottle, for example, wine or liquor, is on the store shelf or is in possession of the consumer after sale, can continue to age or be enhanced in other ways. Cost savings may be realized by omitting the tanks and/or barrels used for holding and/or aging the wine. The wooden pieces may be removed from the bottle at the time the beverage is served and put back in the bottle when the bottle is capped/corked again.

### BACKGROUND

This application relates generally to enhancing beverages in a consumer container. More specifically, this application relates to a removable in-container device for enhancement of beverages, such as wine and/or liquor and/or beer.

### SUMMARY

An in-container beverage enhancement device is disclosed including a container cap for sealing a container, such as a bottle, and a wooden piece, coupled with the container cap, that can be removably inserted into the container.

A method of improving efficiency of making aged wine is disclosed including bottling wine after pressing and filtering grapes, coupling a wooden piece to a cap of a bottle, placing the wooden piece in the bottle, and capping the bottle using the cap.

A method of reducing a cost of wine-making is disclosed including bottling wine after pressing and filtering grapes, saving a cost of holding tanks by skipping holding of the wine in the holding tanks, placing a wooden piece in the bottle, and capping the bottle using the cap.

### BRIEF DESCRIPTION OF THE DRAWINGS

The drawings, when considered in connection with the following description, are presented for the purpose of facilitating an understanding of the subject matter sought to be protected.

FIG. 1 is an example generalized wine and/or liquor making and enhancement process;

FIG. 2A is an example in-container wine and/or liquor and/or beer (or other beverage) enhancement device;

FIG. 2B is an example alternative in-container wine and/or liquor and/or beer (or other beverage) enhancement device;

FIG. 2C is another example alternative in-container wine and/or liquor and/or beer (or other beverage) enhancement device;

FIG. 2D is another example alternative in-container wine and/or liquor and/or beer (or other beverage) enhancement device; and

FIG. 3 is a flow diagram of an example wine and/or liquor and/or beer (or other beverage) enhancement process.

### DETAILED DESCRIPTION

While the present disclosure is described with reference to several illustrative embodiments described herein, it should be clear that the present disclosure should not be limited to such embodiments. Therefore, the description of the embodiments provided herein is illustrative of the present disclosure and should not limit the scope of the disclosure as claimed. In addition, while following description references wine and liquor aging, it will be appreciated that the disclosure may be used for other types of beverage enhancements, such as flavor, fragrance, color, and the like, and is not limited solely to wine and liquor aging.

Briefly described, appropriate types of wooden pieces, such as oak, rosewood, redwood, cedar, birch, or beech sticks, rods, or balls, are removably extended into a beverage container for on-shelf or after-consumer-sale enhancement of beverage. In one embodiment, a wooden dowel is attached to a cork or cap of a wine bottle and extended into the bottle with the cork sealing the bottle. In another embodiment, a string coupled with wooden balls or blocks on one end of the string is coupled with a cork or cap of a bottle on the other end of the string. The string and wooden balls or blocks are extended into the bottle, being submerged in the beverage contained in the container. In yet another embodiment, the wooden pieces can be added in a non-removeable manner without attachment to a cork or cap. This way, while the beverage bottle, for example, wine or liquor, is on the store shelf or is in possession of the consumer after sale, can continue to age or be enhanced in other ways. The wooden pieces may be removed from the bottle at the time the beverage is served, and put back in the bottle when the bottle is capped/corked again, or the wood piece or pieces can remain in the bottle the entire duration.

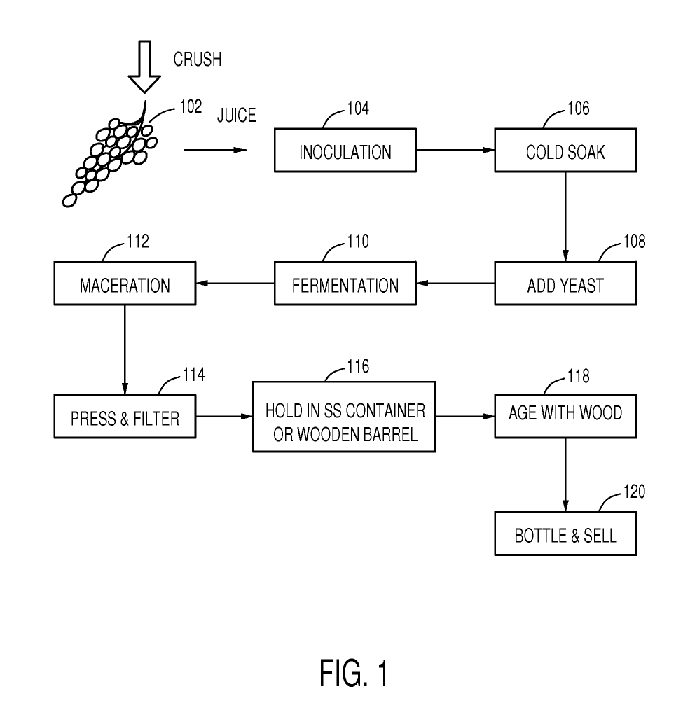

FIG. 1 is an example of a generalized wine and/or liquor making and aging process. Those skilled in the art will appreciate that the process described with respect to FIG. 1 may have fewer or more steps than shown, the steps may be combined or split, and/or the steps may be in a different sequence than shown. In one embodiment, at step 102 grapes are crushed to separate the grape juice. At step 104 the juice may be inoculated with SO2 (sulfur dioxide gas) to serve as an antibiotic and antioxidant, protecting wine from spoilage by bacteria and oxidation. SO2 also helps to keep volatile acidity of wine at desirable levels. S02, typically, in the form of Potassium Meta-Bisulfite is used for inoculation. At step 106, the juice is cold-soaked for 1-40 hours or more. At step 108, yeast is added for fermentation at step 110. Fermentation may last for 3-21 days or more. After fermentation, maceration may take place at step 112 for 1-40 days or more. At step 114, the mix may be pressed and filtered again, if not done initially. At step 116, the fermented juice is held in stainless steel containers or aged in barrels. At step 118, wood pieces, such as oak or beech may be added to the stainless steel containers to start aging the wine and infusing new flavors. Wine evaporates through the wood pores in the wooden barrel and must be topped off to keep the barrel full. At step 120, the wine is bottled and shipped for sale.

For aged wine or liquor to get to market, the wine often remains in production process, where it cannot yet be sold, for years, for example, 6 months-5 years, depending on the desired age and quality. Additionally, as described above, aging in barrels has at least three adverse effects: one, beverage inventory has to be maintained for years without realizing revenue, two, expenses associated with pre-sale aging can be considerable, and three, alcoholic beverages evaporate through porous wooden barrels, wasting some percentage of the production, depending on the type of wooden barrel and duration of aging. In addition, oak barrels can cost about $900 each and have to be changed after a few rounds of service because they lose their effectiveness for aging and flavoring the wine.

Aging wine and/or liquor in bottle or other similar consumer-oriented containers, such as metal cans, or bags in boxes mitigates some or all of the aforementioned disadvantages to a certain extent. It reduces time to market so revenue may be realized earlier in the production cycle; it reduces expenses associated with pre-sale aging; and it reduces or eliminates evaporation of liquor and/or wine through porous containers, such as wooden barrels.

Additionally, aging and/or enhancing beverages, such as wine and liquor, in a bottle or like containers increases the detectable desired characteristics in wine from oak or other wood types, enhances the potential age ability of the wine, reduces the time from harvest until the wine is considered ideal or available to sell, and reduces drink time (the time generally required before product is released for consumption) from as high as five and half years to as little as approximately one month. Furthermore, this in-container process creates another option for winemakers to reduce/eliminate any oxygenation/aeration in wine while providing an oak (or other wood) treatment of wine. Conversely, this methodology allows for the increased micro-oxygenation after bottling using non-degassed wood. This process also provides an opportunity to educate the consumer about the difference in types of wood treatment of wine. The cost savings in pre-sale treatment can also be significant. For example, by substantially reducing or eliminating the cost of an oak barrel from $900 per barrel or about $3 per bottle, the cost of treatment may be reduced to about 5-50 cents per bottle.

Using the in-container enhancement process, the process of wine making may also be considerably simplified by substantially skipping steps 118-120 and/or other steps, with reference to FIG. 1, saving costs of providing stainless steel holding tanks and/or oak (or other wood) barrels, providing potential for wineries to turn over inventory more quickly, and helping provide a bulk wine industry with an exciting and new marketing platform.

The in-container process also allows for more control of the treatment of the beverage, thereby preventing the tendency of “over-oaking” a beverage when new barrels are used or only adding the amount of wood required for the given enhancement. Also, the in-container enhancement process allows the continuation of enhancement, such as aging on oak, after bottling. With this process, customized oak treatment in small batches is also made possible.

This in-container process also gives consumers a chance to purchase wine early (similar to purchasing wine futures) and be able to take possession of wine at the time of purchase. In addition, this in-container process makes the wood aging process more tangible to consumers.

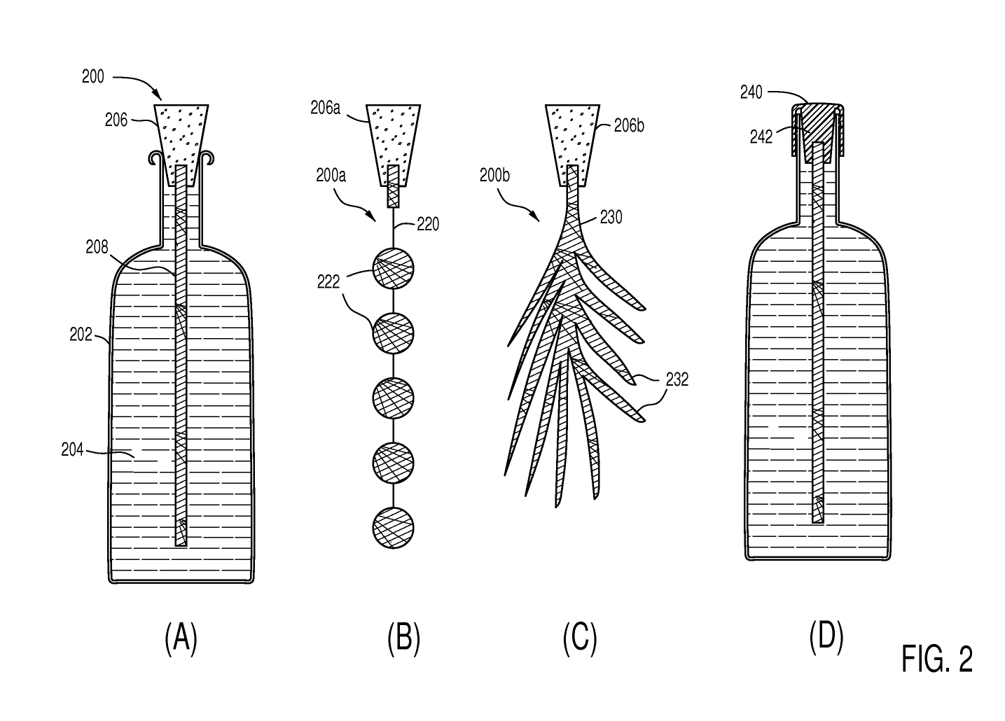

FIG. 2A is an example of in-container wine and/or liquor and/or beer (or other beverage) enhancement device. In one embodiment, removable in-container beverage enhancement device 200 includes a cap 206 and a wooden piece 208 coupled with cap 206. In other embodiments, removable in-container beverage enhancement device 200 may include other components or be made of a single integrated piece. For example, wooden piece 208 may be coupled with cap 206 using a ring, a string, an insert, or other fastening techniques. Wooden piece 208 extends into beverage 204 contained in container 202. In one embodiment, container 202 is a glass bottle. In other embodiments, container 202 may be made of metal, natural or synthetic bag, stone, crystal, treated paper, and the like. In various embodiments, cap 206 may be a cork, a screw-on cap, a plastic or glass plug, and generally any component that can seal the container. In various embodiments, wooden piece 208 may be a dowel, a narrow block, a spiral-shaped block, conical, semi-circle, and the like, that can be easily removed from container 202 by simply lifting cap 206. The removable in-container beverage enhancement device may enhance beverage 204 contained in container 202, by aging it (for example, for wine and liquor), enhancing its flavor and/or fragrance, and/or enhancing/changing its color.

In various embodiments, the wooden pieces of the removable in-container beverage enhancement device may be replaced by the same type or another type of wood to further enhance the beverage or continue aging at a pre-determined rate.

In operation, when the wine (or other beverage) is initially bottled, the removable in-container beverage enhancement device is inserted to start the aging (or other enhancement) process while the bottle is on store shelves. Alternatively, the removable in-container beverage enhancement device may be purchased and applied post-sale by consumer to further enhance the beverage purchased. To serve the beverage, cap 206 is lifted, pulling wooden piece 208 out of beverage 204. Subsequently, for storage, wooden piece 208 may be put back into beverage 204 and cap 206 be closed.

FIG. 2B is an example alternative in-container wine and/or liquor and/or beer (or other beverage) enhancement device. In one embodiment, in-container beverage enhancement device 200a includes string 220 coupled with cork 206a on one end of string 220, and coupled with small wooden blocks or balls 222 on the other end of string 220. In this embodiment, the number, size, and types of wooden balls 222 may be adjusted to effect desired enhancements.

FIG. 2C is another alternative in-container wine and/or liquor and/or beer (or other beverage) enhancement device. In one embodiment, in-container beverage enhancement device 200b includes a shredded wooden piece 230 including branches 232. Shredded wooden piece 230 is coupled with cork 206b. In this embodiment, the number, size, and shapes of branches 232 may be varied to effect desired enhancements. In operation, branches 232 of wooden piece 230 may be held in a closed position to insert into the beverage container at which time the branches expand and increase contact surface with the beverage. When taking wooden piece 230 out for serving or changing, branches 232 are forced together by the narrow end of container, for example, the bottleneck, making extraction of wooden piece 230 from the container easy. FIG. 2C is another alternative in-container wine and/or liquor and/beer (or other beverage) enhancement device. In this embodiment a screw cap 240 is shown with a wooden piece 242 coupled to it such that when a bottle or similar container (not shown) is sealed with the aforementioned cap and wood combination, the contents of the container will be exposed to the wood and receive the enhancement. The wooden piece 242 may be coupled to the underside of the screw cap 240 using friction, restriction, an adhesive, or any other suitable method. It should be appreciated that any of the other wood shapes shown in FIG. 2A-2C (or any other similar shapes) could be utilized with this screw cap embodiment.

Those skilled in the art will appreciate that many other in-container beverage enhancement device and wooden piece configurations are possible without departing from the spirit of the disclosures herein.

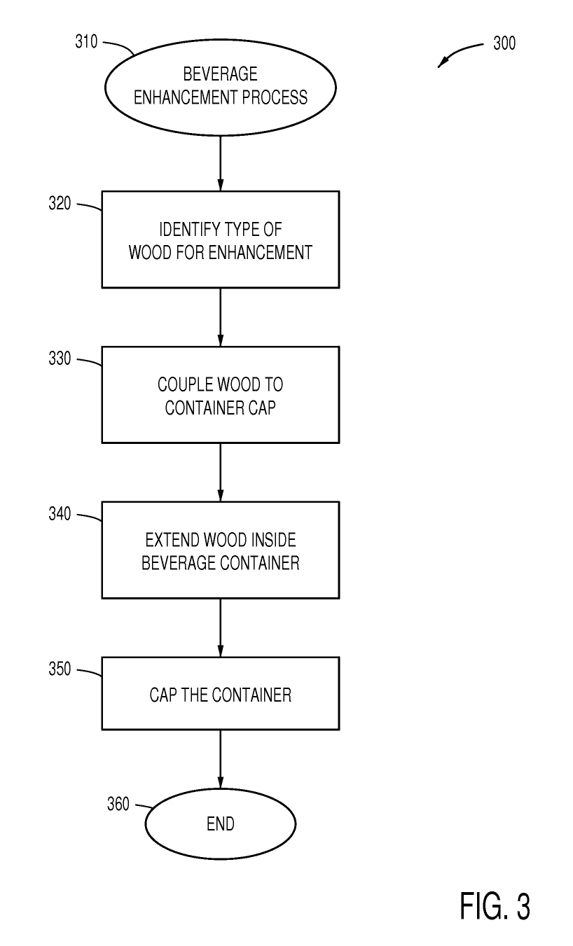

FIG. 3 is a flow diagram of an example wine and/or liquor (or other beverage) enhancement process. Beverage enhancement process 300 starts at block 310 and proceeds to block 320 where the type of wood for beverage enhancement is identified. Various types of wood impart various aging rates and/or flavors to wine and liquor (or other beverage). For example, oak, rosewood, redwood, cedar, birch, beech, or a combination thereof, may be used for this purpose.

At block 330, with reference to FIG. 2A, wooden pieces, such as small balls, blocks, sticks, spirals, cylinders, rods, may be coupled with cap 206 for insertion into bottle (or other type of container) 202 or added to float. Wooden pieces may be coupled with the cap in a variety of ways, including insertion of wooden piece (for example, a dowel) directly into the bottle cork, attaching a hook to cap 206 and passing a string through the hook, a combination of these methods, or any other means of coupling wooden pieces with cap 206. This way, in-container beverage enhancement device 200 is formed.

At block 340, in-container beverage enhancement device 200 is inserted into beverage 204 contained in container 202.

At block 350, cap 206 is closed, sealing the container.

Process terminates at block 360.

While the present disclosure has been described in connection with what is considered the most practical embodiment, it is understood that this disclosure is not limited to the disclosed embodiments, but is intended to cover various arrangements included within the spirit and scope of the broadest interpretation so as to encompass all such modifications and equivalent arrangements.

What is claimed is:

1. An in-container beverage enhancement device comprising:
a container cap configured to seal a container; and
a wooden piece coupled with the container cap configured to be removably inserted into the container.

2. The in-container beverage enhancement device of claim 1, wherein the cap is a cork.

3. The in-container beverage enhancement device of claim 1, wherein the wooden piece is a ball, a block, a strip, a cylinder, a rod, or a spiral.

4. The in-container beverage enhancement device of claim 1, wherein the wooden piece is made of one of oak, rosewood, redwood, cedar, birch, beech, or a combination thereof.

5. The in-container beverage enhancement device of claim 1, wherein the wooden piece comprises a removable branched configuration.

6. The in-container beverage enhancement device of claim 1, wherein the wooden piece causes enhancement of a beverage inside the container.

7. The in-container beverage enhancement device of claim 6, wherein the beverage is one of wine, liquor or beer.

8. The in-container beverage enhancement device of claim 7, wherein the enhancement includes aging of wine, liquor or beer.

9. The in-container beverage enhancement device of claim 7, wherein the enhancement includes adding flavor to wine, liquor or beer.

10. The in-container beverage enhancement device of claim 7, wherein the enhancement includes changing a color of wine, liquor or beer.

11. A method of improving efficiency of making an aged wine, the method comprising:
pressing grapes to produce grape juice;
fermenting the grape juice to produce wine;
omitting holding the wine in a holding tank;
placing the wine in a container for consumer sale; and
including a wooden piece in the container, wherein the wooden piece is configured to enhance the wine.

12. The method of claim 11, further comprising:
omitting aging the wine in wooden barrels to reduce a time duration between pressing the grapes and containing the wine for sale.

13. The method of claim 11, wherein the contained wine is ready for consumer sale at least as early as approximately 1 month after pressing the grapes.

14. The method of claim 11, wherein the wooden piece is made of one of oak, rosewood, redwood, cedar, birch, beech, or a combination thereof.

15. The method of claim 11, wherein the wooden piece is configured to be removable.

16. The method of claim 11, wherein the wooden piece is a ball, a block, a strip, a cylinder, a rod, or a spiral is attached to a portion of a cap.

17. A method of reducing the cost of wine-making, the method comprising:
pressing grapes to produce grape juice;
fermenting the grape juice to produce wine;
saving a cost of holding tanks by omitting holding the wine in the holding tanks;
placing the wine in a container for consumer sale; and
including a wooden piece in the container, wherein the wooden piece is configured to enhance the wine.

18. The method of claim 17, further comprising saving cost of wooden barrels by omitting aging of the wine in the wooden barrels.

19. The method of claim 17, wherein the wooden piece is coupled with a cap of the container.

20. The method of claim 17, wherein the wooden piece is configured to be removable.
